(19) United States
(12) Patent Application Publication
(10) Pub. No.: US 2017/0011439 A1
(43) Pub. Date: Jan. 12, 2017

(54) SYSTEMS AND METHODS FOR MANAGING COMPLIANCE WITH ONE OR MORE MINIMUM ADVERTISED PRICING POLICIES VIA INTERCONNECTED DATA STRUCTURES

(71) Applicant: Viesoft, Inc., San Francisco, CA (US)

(72) Inventor: Anthony Vierra, San Francisco, CA (US)

(21) Appl. No.: 15/269,717

(22) Filed: Sep. 19, 2016

Related U.S. Application Data
(63) Continuation-in-part of application No. 14/477,108, filed on Sep. 4, 2014.
(60) Provisional application No. 62/220,198, filed on Sep. 17, 2015.
(60) Provisional application No. 62/006,233, filed on Jun. 1, 2014.

(51) Int. Cl. G06Q 30/06; G06Q 10/08

(52) U.S. Cl. CPC G06Q 30/0609; G06Q 10/087

(57) ABSTRACT

A system and method of creating one or more direct connections between a manufacturer computer system and one or more third party retailer computer systems for the transfer of product and minimum advertised practicing (MAP) data. In various embodiments, the system is configured to maintain a database of manufacturer product data and automatically update a corresponding database of third party retailer product data to include changes to the manufacturer product data. In particular embodiments, the system is configured to authorize requests to list manufacturer products for sale by retailers based on the third party retailer product data.

### BACKGROUND

In general, manufacturers set minimum advertised price (“MAP”) policies in an effort to maintain consistency in pricing. Typically, there are no structured ways to communicate current MAP policies or updates to these MAP policies to retailers of the manufacturer's products. In addition, manufacturers may or may not have effective programs for policing MAP policies. Thus, if MAP policies are not effectively enforced, complying retailers may become disgruntled and may even potentially stop complying with the policies. Currently, it takes manufacturers significant time and effort to police, monitor, and enforce MAP policies. Also, it takes retailers a significant amount of time and effort to stay up to date and to comply with various manufacturers' individual MAP policies. Accordingly, there is currently a need for more efficient systems and methods for implementing and enforcing MAP policies.

### SUMMARY

In particular embodiments, a computer system for facilitating enforcement of one or more MAP guidelines for a plurality of products from a manufacturer of the products by establishing a direct connection between the manufacturer and each of a plurality of third party marketplaces for the transfer of product data and MAP data comprises at least one processor and memory. In various embodiments, the computer system further comprises: (1) executable software operatively installed on a manufacturer computing device associated with the manufacturer, the executable software displaying a user interface, on a display screen of the manufacturer computing device, that is adapted to receive, via input on the user interface, updated product data and updated MAP data; (2) executable software operatively installed on a computing device associated with each of the plurality of third party marketplaces, the executable software displaying a user interface, on a display screen of the computing device, that is adapted to receive a request to authorize a new seller to list a particular one of the plurality of products via a particular one of the plurality of third party marketplaces; (3) a manufacturer database storing the product data and the MAP data; and (4) one or more third party retailer databases associated with each of the plurality of third party marketplaces and storing corresponding product data, corresponding MAP data, and third party manufacturer data. In various embodiments the system is configured for: (1) establishing a connection between the manufacturer database and the one or more third party retailer databases; (2) in response to receiving updated product data and updated MAP data from the manufacturer, automatically updating the corresponding product data and the corresponding MAP data; (3) in response to receiving the request to authorize the new seller to list the particular one of the plurality of products via a particular one of the plurality of third party marketplaces, automatically determining whether to authorize the new seller to list the particular one of the plurality of products based at least in part on the corresponding product data and the corresponding MAP data; (4) in response to determining not to authorize the new seller to list the particular one of the plurality of products, modifying the product data to include data associated with the new seller as an unauthorized seller; and (5) in response to modifying the product data to include data associated with the new seller as an unauthorized seller, automatically updating the corresponding product data to include the data associated with the new seller as an unauthorized seller.

A computer-implemented method of facilitating enforcement of one or more MAP guidelines for a plurality of products from a manufacturer, in various embodiments, establishes a direct connection between a manufacturer and a third party marketplace. In particular embodiments, the method comprises: (1) receiving, by a processor, a request to establish a connection between the manufacturer and the third party marketplace to facilitate enforcement of the one or more MAP guidelines form the manufacturer; (2) at least partially in response to receiving the request, establishing the connection by a processor, wherein establishing the connection comprises: (a) establishing a direct communication channel between a manufacturer database storing manufacturer product data for the plurality of products and a third party retailer database storing third party retailer product data for the plurality of products; (b) creating a link, in memory, between the manufacturer product data and the third party retailer product data; (c) enabling the manufacturer to provide the one or more MAP guidelines to the third party marketplace via the direct communication channel; and (d) enabling the third party marketplace to provide data associated with one or more sellers requesting to sell one or more manufacturer products via the third party marketplace to the manufacturer via the direct communication channel; (3) receiving, by a processor, the one or more MAP guidelines from the manufacturer; (4) in response to receiving the one or more MAP guidelines from the manufacturer, modifying the manufacturer product data to include the one or more MAP guidelines; (5) in response to modifying the manufacturer product data to include the one or more MAP guidelines, automatically transferring the modified manufacturer product data via the direct communication channel and modifying the third party retailer product data to include the one or more MAP guidelines; (6) receiving a request from a seller to list one or more manufacturer products on the third party marketplace; (7) determining, by a processor, based at least in part on the third party retailer product data, whether to enable the seller to list the one or more manufacturer products on the third party marketplace; (8) at least partially in response to determining to enable the seller to list the one or more manufacturer products, enabling the seller, by a processor, to list the one or more manufacturer products on the third party marketplace; and (9) providing a notification, by a processor, to the manufacturer from the third party marketplace detailing the determination made at Step 7 via the direct communication channel.

### BRIEF DESCRIPTION OF THE DRAWINGS

Various embodiments of a system and method for managing compliance with one or more MAP policy are described below. In the course of this description, reference will be made to the accompanying drawings, which are not necessarily drawn to scale, and wherein:

FIG. 1 is a block diagram of a MAP compliance server in accordance with an embodiment of the present system;

FIG. 2 is a schematic diagram of a computer, such as the MAP compliance server of FIG. 1, that is suitable for use in various embodiments;

FIG. 3 depicts a flow chart that generally illustrates various steps executed by a MAP compliance communication module that, for example, may be executed by the MAP compliance server of FIG. 1;

FIG. 4 depicts a flow chart that generally illustrates various steps executed by a MAP compliance policing module that, for example, may be executed by the MAP compliance server of FIG. 1;

FIG. 5 depicts a flow chart that generally illustrates various steps executed by a MAP compliance reporting and enforcing module that, for example, may be executed by the MAP compliance server of FIG. 1;

FIG. 6 depicts a flow chart that generally illustrates various steps executed by a MAP compliance monitoring module that, for example, may be executed by the MAP compliance server of FIG. 1;

FIG. 7 depicts an example of a user interface showing a particular retailer's price grid that tracks and displays MAP compliance; and

FIG. 8A-8C depict examples of a user interface that allow a retailer to check pricing against a manufacturer's MAP, check competitor pricing against a manufacturer's MAP and submit potential MAP violations to the manufacturer.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A MAP compliance system according to various embodiments is adapted to: (A) facilitate communication of MAP information between manufacturers and retailers; (B) facilitate policing of current MAP policies by both manufacturers and retailers; (C) encourage compliance with current MAP policies; and (D) facilitate communication between retailers who are allegedly violating current MAP policies in order to either end the violation of the policies or to resolve a misunderstanding, on behalf of the manufacturer, that the retailer is in violation of a MAP policy when, in fact, no violation has occurred.

In particular embodiments, in facilitating the communication of MAP information between manufacturers and retailers, the system is adapted to receive a first set of data about a particular MAP for a particular product. The MAP information will include information such as the specific product, the specific price, and other information related to when and how the price can be changed. After receiving the MAP information, the system is adapted to store the MAP information and transmit this information to all retailers currently selling the particular product. If the manufacturer updates the MAP policy for a particular product, the system will receive a second set of data that includes the updated MAP information. As with the first set of data, the system will store and transmit the information pertaining to the second set of data directly to the retailers currently selling the particular product. This information may be transmitted via electronic communication such as an instant message, email, or a pop-up notification on the retailer's computer.

The system is also adapted to receive requests from the retailers to verify current or proposed pricing schedules for a particular product. The retailers may also verify pricing schedules of competitors that are also using the system. In verifying these pricing schedules, the system will first receive data relating to the current MAP for a particular product from a manufacturer and store this data until a request has been made by a retailer. Once the retailer makes a request to confirm the pricing schedule, the system will compare the retailer's price with the MAP, as stated by the manufacturer. If the retailer's price is above or equal to the MAP, the system will notify the retailer that the retailer's price complies with the manufacturer's MAP. However, if the retailer's price is below the MAP, the system will notify the retailer that the retailer's price does not comply with the manufacturer's MAP.

The system is further adapted to allow retailers to police other retailers' pricing activities. For example, one retailer may use the system to determine whether its competitor is meeting or exceeding the MAP set by the manufacturer for a particular product sold by the retailers. If the competitor's price is lower than the manufacturer's MAP, the retailer may use the system to notify the manufacturer that the competitor's price does not comply with the manufacturer's MAP. The system may then allow the competitor and the manufacturer to resolve the discrepancy and potentially notify other retailers of the resolution.

In addition, the system is further adapted to permit manufacturers to police retailers' pricing activities for particular products. For example, the system will receive a particular retailer's price for a particular product directly from the retailer's website. After receiving the information from the retailer's website, the system may send a notification to the retailer stating that the retailer's price for the particular product either does or does not comply with the manufacturer's MAP policy. In addition, the system may inform the manufacturer of non-complying retailers.

In various embodiments, the system is configured to enforce MAP policies by, for example, facilitating connections between a manufacturer and one or more retails, distributors, or other entities in the supply chain of one or more products produced by the manufacturer. For example, the system may generate and maintain a database of a plurality of products produced by the manufacturer. The database may include, for example, a particular entry for each particular product (e.g., or model of product) offered by the manufacturer. The system may, for each of the particular products, store (e.g., in memory associated with each particular product) a plurality of data fields such as, for example: (1) Product Name; (2) Product Descriptions; (3) Brand Name; (4) Brand Stock Keeping unit (SKU); (5) MSRP; (6) MAP; (7) One or more names of prohibited marketplaces; (8) Closeout status (e.g., whether the item is a closeout item); (9) Size; (10) gender designation; (11) Shape; (12) Color; (13) One or more images of the one or more products (e.g., one or more image files, one or more links to one or more hosted images, etc.); (14) Style Code; (15) Series; (16) Category; and/or (17) any other data field associated with the product.

The system may then, in various embodiments, enable manufacturers to update data fields for particular products and, in response, automatically push the updated data fields to one or more connected retailers, distributers, etc. In this way, in various embodiments, the system may enable manufacturers to approve new connection requests across a vast distribution network by generating new data fields for a particular seller (e.g., that indicate via a Boolean value or other suitable data entry) that indicate that the particular seller is an approved retailer. For example, if a first distributer receives a request from a first seller to purchase a manufacturer's product for resale, the first distributer may pass on a connection request from the first seller to the manufacturer. The manufacturer may then approve the first seller as an authorized re-seller by updating a data structure to include data associated with the first seller for the particular product. In response, the system may push the updated data structure to one or more other distributers such that future requests by the first seller to purchase inventory from the one or more other distributors may occur substantially automatically.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, or an embodiment combining software and hardware aspects. Furthermore, particular embodiments may take the form of a computer program product stored on a computer-accessible storage medium having computer-readable instructions (e.g., software) embodied in the storage medium. Various embodiments may take the form of web-implemented computer software. Any suitable computer-accessible storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions (e.g., a computer-implemented method). These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

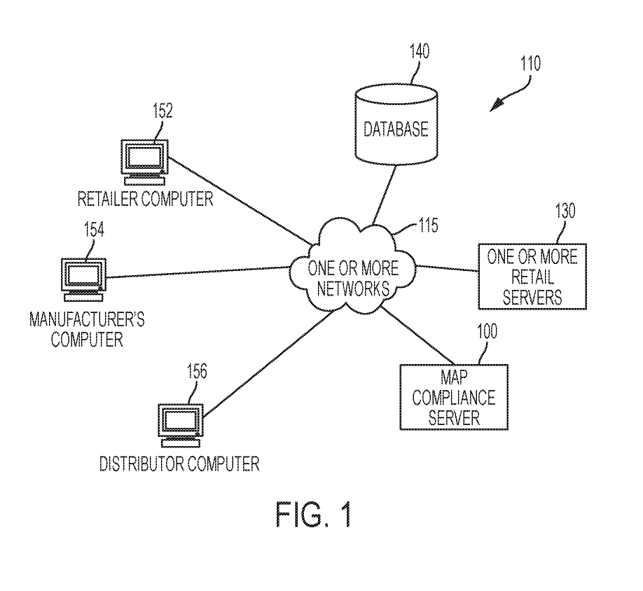

FIG. 1 is a block diagram of a System 110 according to a particular embodiment. As may be understood from this figure, the System 110 includes one or more computer networks 115, a MAP Compliance Server 100, One or More Retail Servers 130, a Database 140, and one or more computing devices such as a retailer computer 152 (e.g., such as a smart phone, a tablet computer, a wearable computing device, a laptop computer, etc.), a manufacturer's computer 154, or a distributor's computer 156. In particular embodiments, the one or more computer networks 115 facilitate communication between the MAP Compliance Server 100, One or More Retail Servers 130, the Database 140, and the one or more computing devices 152, 154, 156.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between the MAP Compliance Server 100 and Database 140 may be, for example, implemented via a Local Area Network (LAN) or via the Internet.

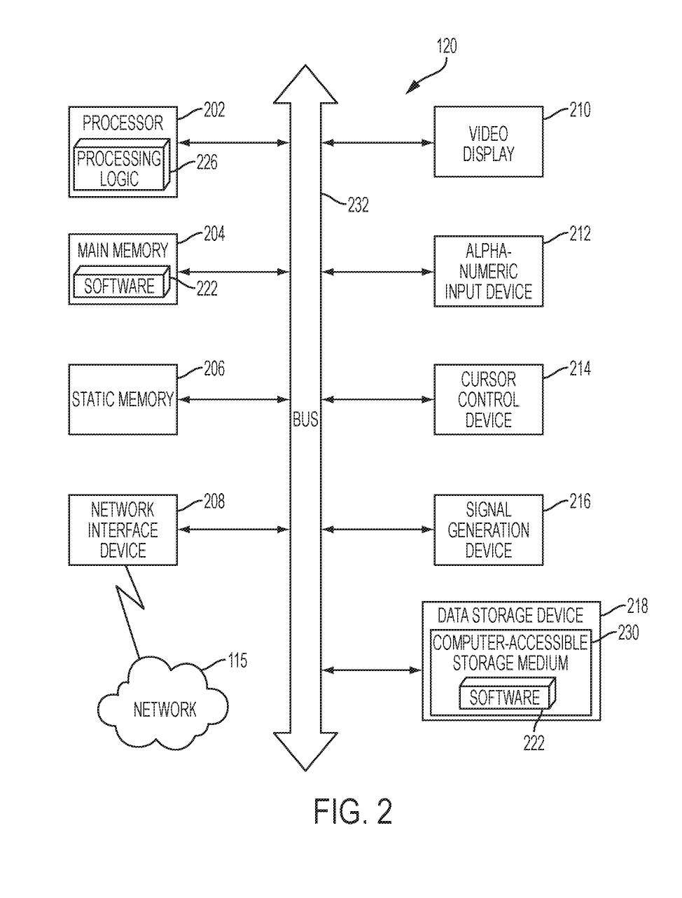

FIG. 2 illustrates a diagrammatic representation of a computer 120 that can be used within the System 110, for example, as a client computer (e.g., one of the computing devices 152, 154, 156 shown in FIG. 1), or as a server computer (e.g., MAP Compliance Server 100 shown in FIG. 1). In particular embodiments, the computer 120 may be suitable for use as a computer within the context of the System 110 that is configured for collecting, tracking, and storing MAP compliance data.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions 222 (e.g., MAP Compliance Communications Module 300, MAP Compliance Policing Module 400, MAP Compliance Reporting & Enforcing Module 500, and MAP Price Compliance Monitoring Module 600) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding or carrying a set of instructions for execution by the computer and that cause the computer to perform any one or more of the methodologies of the present invention. The terms “computer-accessible storage medium” and “computer-readable medium” should accordingly be understood to include, but not be limited to, solid-state memories, optical and magnetic media, etc.

### Exemplary System Methods

As noted above, a MAP Compliance System according to various embodiments is adapted to perform a variety of different functions relating to MAP compliance and the resolution of violations of MAP policies. It should be understood by reference to this disclosure that the methods describe an exemplary embodiments of method steps carried out by the present system, and that other exemplary embodiments may be created by adding other steps, by removing one or more of the method steps, or performing one or more of the method steps in an order other than the order in which they described in Figures. Exemplary functionality of certain embodiments of the system is described below.

### MAP Compliance Communication Module

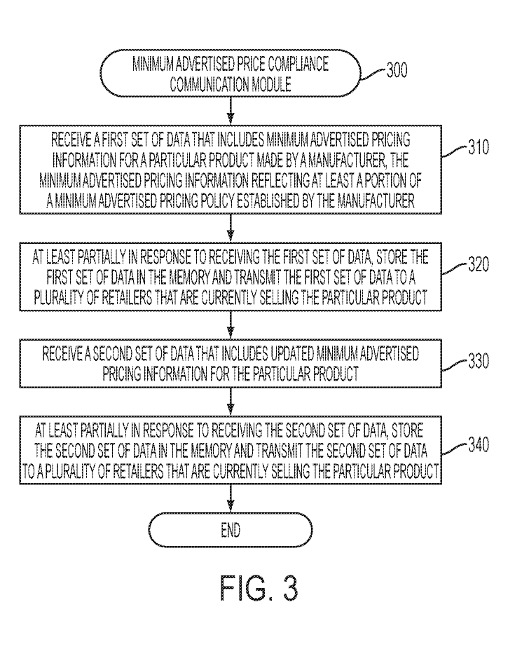

FIG. 3 is a flow chart of operations performed by an exemplary MAP Compliance Communication Module 300, which may, for example, run on the MAP Compliance Server 100, or any suitable computing device (such as a suitable mobile computing device). In particular embodiments, the MAP Compliance Communication Module 300 may facilitate the storing and distributing of MAP compliance data.

In various embodiments, the system begins at Step 310 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. The MAP policy may include MAP information for one or more products made by the manufacturer. The MAP information may include information such as price, date, geographic area, etc. for the MAP of a particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30.

In various embodiments, the system may generate a data structure for a particular product of a particular manufacturer, and store in memory associated with the data structure, one or pieces of first data for the first product such as: (1) Product Name; (2) Product Descriptions; (3) Brand Name; (4) Brand Stock Keeping unit (SKU); (5) MSRP; (6) MAP; (7) One or more names of prohibited marketplaces; (8) Closeout status (e.g., whether the item is a closeout item); (9) Size; (10) gender designation; (11) Shape; (12) Color; (13) One or more images (e.g., one or more image files, one or more links to one or more hosted images, etc.); (14) Style Code; (15) Series; (16) Category; and/or (17) any other data field associated with the product.

In various embodiments, a particular data structure for a particular product may be broken down into a plurality of fields. In such embodiments, the system may store, within the data structure, one or more entries for each particular field (e.g., a string, Boolean value, number etc.). In various embodiments, the one or more fields may include any of the one or more pieces of data described above (e.g., product name, SKU, MAP, etc.).

Next, at Step 320, the system continues by, at least partially in response to receiving the first set of data, storing the first set of data in the memory and transmitting the first set of data to a plurality of retailers that are currently selling the particular product. In various embodiments, the system may be configured to substantially automatically store and transmit the first set of data to the plurality of retailers. In particular embodiments, the system may be configured to transmit the first set of data on a particular date, for example, the first day of every month. In various embodiments, the system may store the first set of data in memory in a first data structure. In such embodiments, the system may further push the stored first set of data to one or more databases associated with a plurality of retailers for storage in memory associated with each of the plurality of retailers (e.g., on the One or More Retail Servers). In particular embodiments, the system is configured to automatically push the first set of data to any of a plurality of retailers and/or distributers with whom the manufacturer has established a connection (e.g., as will be discussed below).

At Step 330, the system receives a second set of data that includes updated MAP information for the particular product. For example, the updated MAP information for the particular product may raise the MAP from $100 to $110 due to high demand for the particular product. In various embodiments, the second set of data may include any suitable change to the first set of data, including changes to price, date, geographic area, etc. for the MAP of the particular product. In particular embodiments, for example, the manufacturer may make one or more changes to a listing for a particular product and/or update one or more MAP guidelines for the particular product. The system may, for example, receive the second set of data in response to submission of the one or more changes by the manufacturer.

Continuing at Step 340, the system, at least partially in response to receiving the second set of data, stores the second set of data in the memory and transmits the second set of data to a plurality of retailers that are currently selling the particular product. In particular embodiments, the system modifies the data structure to include the updated data. In various embodiments, the system may be configured to substantially automatically store and transmit the second set of data to the plurality of retailers. In particular embodiments, the system may be configured to transmit the second set of data on a particular date, for example, the first day of every month. In other embodiments, the system may substantially automatically transmit the second set of updated data to a plurality of connected retailers in response to receiving the second set of updated data from the manufacturer. In such embodiments, the system may enable the connected retailers to retrieve data for the manufacture's product offerings without having to query a manufacturer database for up-to-date product listing or MAP compliance data (e.g., because the data has been automatically pushed to a retailer database). Such an arrangement may, in various embodiments, conserve computing and networking resources at a time at which the data is required by the connected retailers.

### MAP Compliance Policing Module

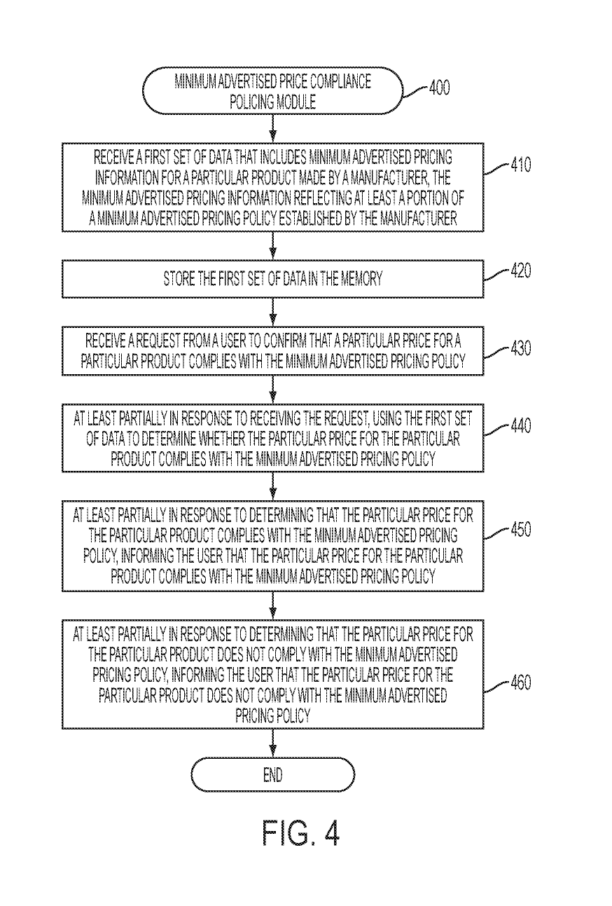

FIG. 4 is a flow chart of operations performed by an exemplary MAP Compliance Policing Module 400, which may, for example, run on the MAP Compliance Server 100, or any suitable computing device. In particular embodiments, the MAP Compliance Policing Module 400 may store MAP compliance data and inform a user as to whether a particular price violates a MAP policy.

Beginning at Step 410, the system receives a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $150 for the period between June 1 and July 31 and $125 for the period between August 1 and September 30. Thus, the first set of data may include information such as price, date, geographic area, etc. for the MAP of the particular product.

At Step 420, the system continues by storing the first set of data in the memory. In various embodiments, the system may be configured to substantially automatically store the first set of data in the memory.

Continuing to Step 430, the system receives a request from a user to confirm that a particular price for a particular product complies with the MAP policy. In various embodiments, the user is a competitor of a retailer that is offering the particular product at the particular price. For example, the user may want to confirm that its own price for a particular product complies with the MAP policy. In addition, the user may want to confirm that a competitor's price for a particular product complies with the MAP policy. In various embodiments, the request from the user may be to confirm that a proposed pricing structure would comply with the MAP policy. In particular embodiments, the request from the user may also be a request to notify the manufacturer of a violation of a MAP policy by the user.

In various embodiments, the request may include a table of one or more fields having one or more Boolean values. In various embodiments, the one more fields may be substantially automatically populated based on the received first set of data for a particular product described above with respect to the MAP Compliance Communication Module. The one or more fields may include, for example, one or more fields such as: (1) is this a listing for the particular product; (2) does the listing offer the product below the MAP guideline; (3) etc. In various embodiments, the system is configured to automatically determine Boolean values for the one or more fields based on the communicated product data from the manufacturer (e.g., by comparing a product description or SKU to the product description or SKU from a product listing at issue).

Limiting requests to confirm whether a particular product listing is in violation of one or more MAP policies may to tables including one or more fields and associated Boolean values may, for example, limit a file size of such requests and improve responsiveness of manufacturers by pre-populating requests based on provided data.

Next, at Step 440, the system, at least partially in response to receiving the request from Step 430, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy.

The system continues at Step 450 by, at least partially in response to determining that the particular price for the particular product complies with the MAP policy, informing the user that the particular price for the particular product complies with the MAP policy. In various embodiments, the system may inform the user that the particular price for the particular product complies with the MAP policy via an electronic communication generated by the system. In some embodiments, the electronic communication may be substantially simultaneously to the request by the user. In other embodiments, the electronic communication may be by e-mail, text message, automated phone call, instant message or by any other suitable means of electronic communication.

At Step 460, the system, at least partially in response to determining that the particular price for the particular product does not comply with the MAP policy, informs the user that the particular price for the particular product does not comply with the MAP policy. In various embodiments, the system may inform the user that the particular price for the particular product does not comply with the MAP policy via an electronic communication generated by the system. In other embodiments, the system may automatically initiate an enforcement action against the seller that is selling the particular product in violation of the MAP policy. The enforcement action may include, for example, stopping sales and/or shipment of one or more products to the violating seller, or any other suitable enforcement action. In particular embodiments, after informing the user that the particular price does not comply with the MAP policy, the system may receive a dispute from the user disputing the violation of the MAP policy.

### MAP Compliance Reporting and Enforcing Module

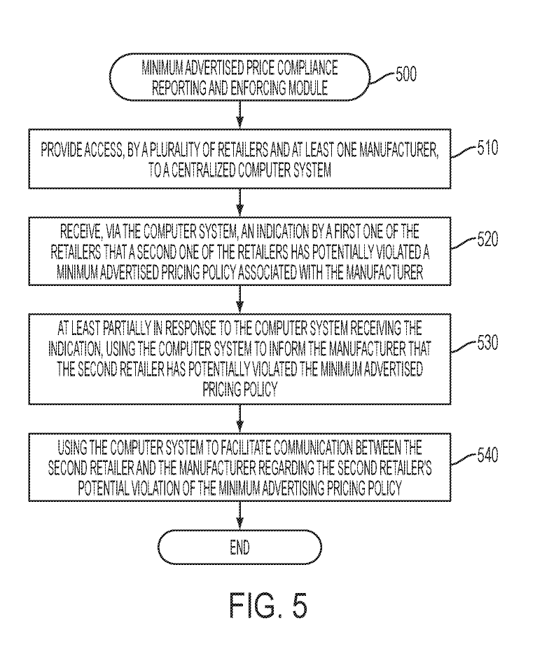

FIG. 5 is a flow chart of operations performed by an exemplary MAP Compliance Reporting and Enforcing Module 500, which may, for example, run on the MAP Compliance Server 100, or any suitable computing device. In particular embodiments, the MAP Compliance Reporting and Enforcing Module 500 may facilitate reporting and enforcing of MAP policies.

To begin with, at Step 510, the system provides access, by a plurality of retailers and at least one manufacturer, to a centralized computer system. Access to the computer system may be provided through the Internet, a LAN, a WAN, or any other suitable network that is adapted to facilitate communication between the retailers and the at least one manufacturer.

Continuing to Step 520, the system receives, via the computer system, an indication by a first one of the retailers that a second one of the retailers has potentially violated a MAP policy associated with the manufacturer. In particular embodiments, the indication may be an electronic communication between the first retailer and the system regarding the second retailer's alleged violation of the MAP policy.

At Step 530, the system, at least partially in response to the computer system receiving the indication, uses the computer system to inform the manufacturer that the second retailer has potentially violated the MAP policy. In various embodiments, the system may inform the manufacturer of the second retailer's violation by electronic communication. For example, after receiving the indication from the first retailer, the system may send the first retailer's note directly to the manufacturer. In other embodiments, the system may inform the manufacturer using a pop-up notification, e-mail notification, an instant message, a text message, an automated phone message where the user presses a key to indicate that the understand the message, or any other suitable means of electronic communication.

Following Step 530, at Step 540, the system uses the computer system to facilitate communication between the second retailer and the manufacturer regarding the second retailer's potential violation of the MAP policy. In various embodiments, the system may facilitate communication by electronic communication. Such communications may include, for example: (1) a communication from the manufacturer to the second retailer that includes the MAP policy and the alleged violation of the MAP policy including the actual price used by the second retailer for the particular product; (2) a communication from the second retailer to the manufacturer that includes the second retailer's position as to why the second retailer's pricing of the particular product does not violate the manufacturer's MAP policy; and (3) a response to this communication from the manufacturer as to whether the manufacturer still believes, after reviewing the communication from the second retailer, that the second retailer's pricing of the item violates the manufacturer's MAP policy for the particular item. This step allows the second retailer and the manufacturer to resolve any alleged MAP violations. Following the resolution of the second retailer's alleged MAP violation, in various embodiments, the system may inform the first retailer as to the outcome of the communications between the second retailer and the manufacturer regarding the second retailer's alleged violation of the MAP policy.

### MAP Compliance Monitoring Module

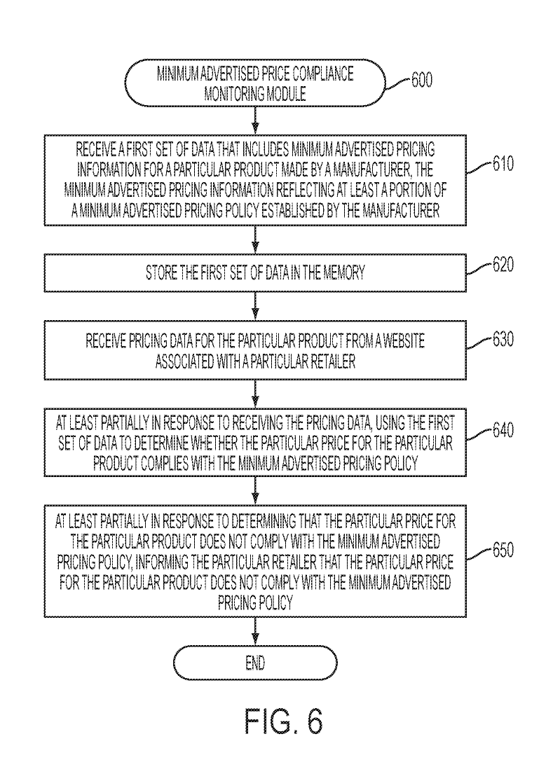

FIG. 6 is a flow chart of operations performed by an exemplary MAP Compliance Monitoring Module 600, which may, for example, run on the MAP Compliance Server 100, or any suitable computing device. In particular embodiments, the MAP Compliance Monitoring Module 600 may store MAP compliance data, directly monitor compliance with MAP policies, and facilitate enforcement of MAP policies.

In various embodiments, the system begins at Step 610 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30. Thus, the first set of data may include information such as price, date, geographic area, etc. for the MAP of the particular product.

At Step 620, the system stores the first set of data in the memory. In various embodiments, the system may be configured to substantially automatically store the first set of data in the memory.

Next, at Step 630, the system receives pricing data for the particular product from a website associated with a particular retailer. In particular embodiments, the system may receive general pricing data from the retailer's website by conducting a search on the retailer's website for the particular product from any computer. In various embodiments, the system may receive pricing data using a computer located in a particular region to access the website. For example, some retailers may offer one or more products at different prices based at least in part on a location from which a customer's computer accesses the retailer's website. In such embodiments, the system may be configured to provide pricing information to the manufacturer that includes the pricing information for the one or more regions or geographic locations.

Continuing to Step 640, the system, at least partially in response to receiving the pricing data, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy. In various embodiments where the system obtains different retailer pricing based on differing geographic access points, the system may be configured to check each price against the MAP policy since the MAP policy may contain different price points based on geographic location.

At Step 650, at least partially in response to determining that the particular price for the particular product does not comply with the MAP policy, informing the particular retailer that the particular price for the particular product does not comply with the MAP policy. In various embodiments, the system may inform the user that the particular price for the particular product does not comply with the MAP policy via an electronic communication generated by the system. In particular embodiments, the system may inform the retailer about all MAP violations at the same time, for instance, at the end of every day, or in the alternative, the system may notify the retailers of MAP noncompliance substantially automatically when a price does not comply. In various embodiments, the system may bundle all non-complying prices for all products into a single notification to the retailer. In other embodiments, the system may show all prices that comply with a MAP policy in green and all prices that do not comply with a MAP policy in red so that the user can easily distinguish those prices in compliance from those prices that are out of compliance. In various embodiments, the system may be configured to automatically monitor the particular price for the particular product at present intervals, continuously or manually. In any case, the system may be configured to notify the retailer when the system detects that the particular price for the particular product is not in compliance with the MAP policy.

### Exemplary User Interface

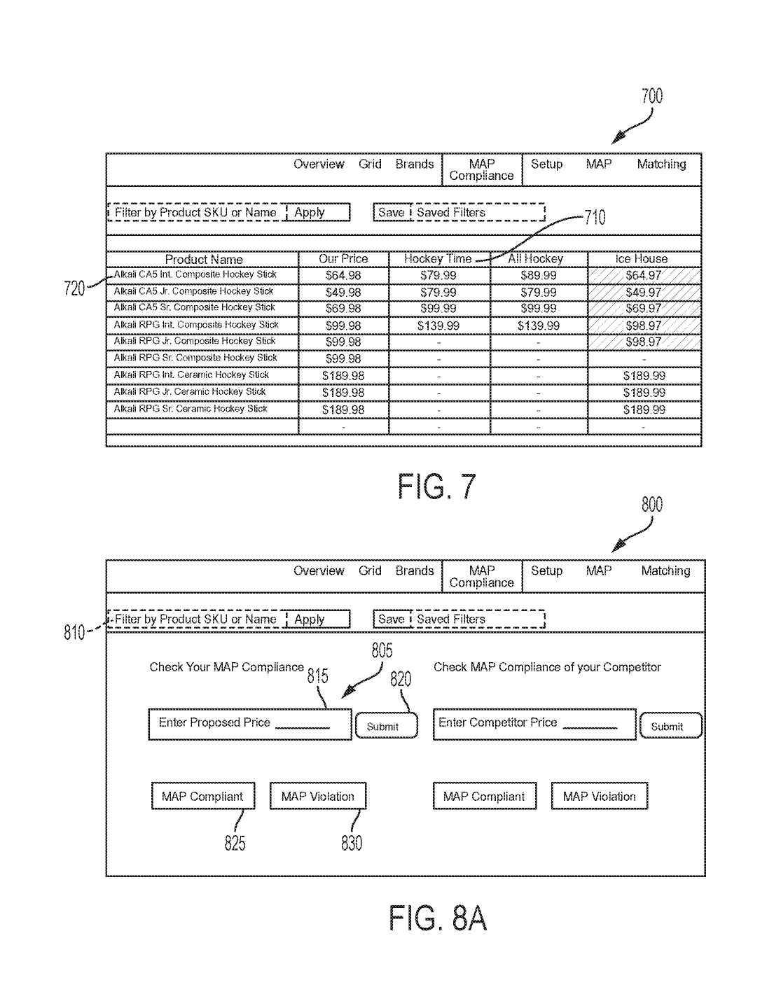

FIG. 7 depicts a user interface 700 that a user may use to confirm compliance with one or more MAP policies. As may be understood from this figure, the interface 700 may include one or more competitor columns 710 that the user may use to confirm whether one or more particular competitors are complying with a particular MAP policy for a particular product. In particular embodiments, the interface 700 may further include a color scheme using red (shown by the cross hatched lines) for noncompliance and green (shown as shaded) for compliance, which corresponds generally to the colors of a stop light, and allow the user to quickly assess the overall compliance with a particular MAP policy for a particular product. For example, the first row 720 shows that the user's company is currently charging $64.98 for the product Alkali CA5 Int. Composite Hockey Stick, while the competitor Hockey Time is charging $79.99 and the competitor Ice House is charging $64.97 for the product. Also, assume the manufacturer has set a MAP of $64.98 in the manufacturer's MAP policy. Because the competitor Hockey Time's price is above the particular MAP, the competitor's price is shown shaded. However, because the competitor Ice House's price is below the particular MAP, the competitor's price is shown with cross hatching. In this way, the user can easily identify pricing that is compliance and pricing that violates the manufacturer's MAP.

### Exemplary User Experience

### MAP Compliance Communication Module User Experience

The following describes an exemplary user experience using the MAP Compliance Communication Module 300. To begin with, a manufacturer will have an established MAP policy that will designate a particular MAP for a particular product. For instance, the manufacturer, Acme Bats may have a product, the Bomber 2000, with a nationwide MAP policy for the bat of $49.99. The manufacturer, by accessing the MAP Compliance Server 100 will enter the MAP policy into the system using their computer (e.g., a manufacturer's computer, such as manufacturer computer 154 shown in FIG. 1). The system will store the particular MAP policy of $49.99 for the Bomber 2000 as well as send out a notification of the current MAP via the one or more networks 115 to all the retailers currently selling the Bomber 2000. The retailers would then be able to see the MAP for the Bomber 2000 by logging onto their computer (e.g., a retailer's computer, such as retail computer 152 shown in FIG. 1).

If the manufacturer decides to update the MAP for the Bomber 2000, for instance to lower the price of the MAP, the manufacturer may log onto the system and access the MAP Compliance Server 100 in the same way as before. The manufacturer may then enter the new MAP policy of $39.99, for example using their computer. Once the manufacturer has changed the MAP from $49.99 to $39.99 MAP, the system will automatically send out a notification of the new MAP to all the retailers selling the particular product. The retailers may receive this notification the next time they log onto the system or via email depending upon the retailer's preferences. Using this system, for example, the manufacturer may raise or lower the MAP, discontinue using the MAP, or change other specifics related to the MAP such as geographic information or dates. Because this is an automatic update to all of the retailer's user interfaces, retailers currently selling the particular product will not have to search for the current MAP for the particular product.

### MAP Compliance Policing Module User Experience

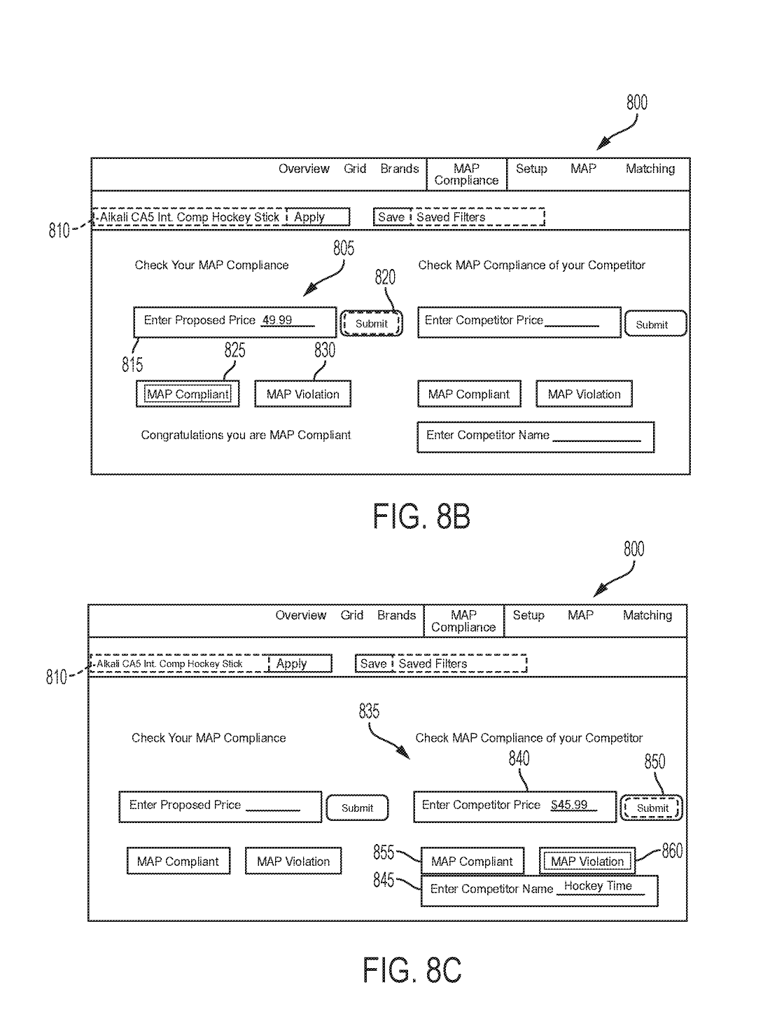

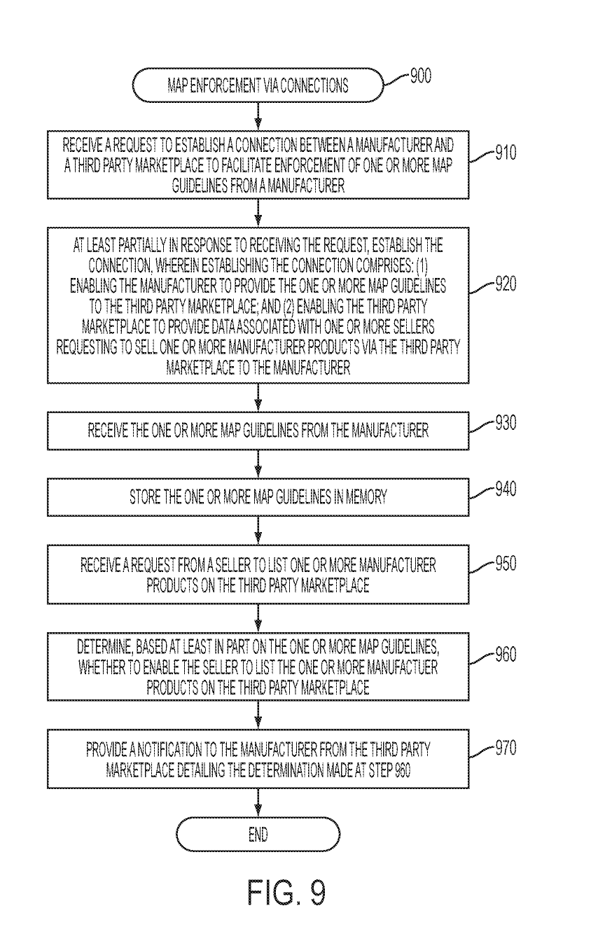

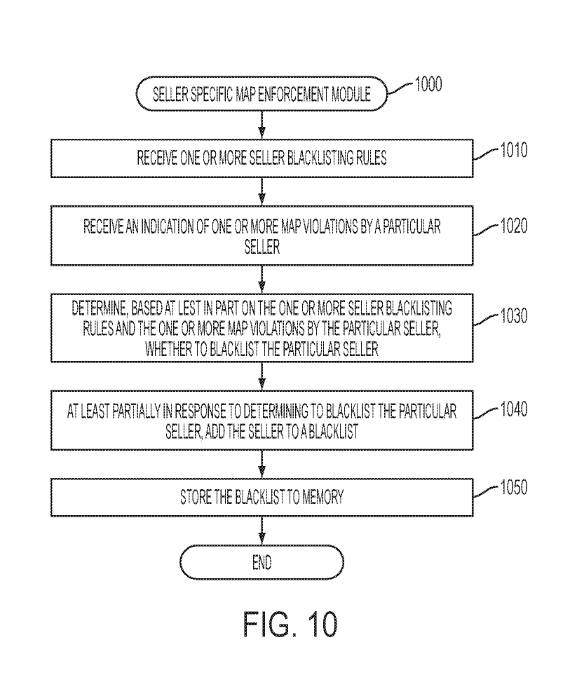

The following describes an exemplary user experience using the MAP Compliance Policing Module 400. Using this module allows retailers looking to raise or lower the price of a particular product, for example the Alkali CA5 Int. Comp Hockey Stick, to confirm that the new price will comply with the manufacturer's MAP policy. For example, a particular sporting goods retailer, Hockey R Us, may wish to sell the Alkali CA5 Int. Comp Hockey Stick made by the manufacturer Alkali. Hockey R Us may wish to offer the Alkali CA5 Int. Comp Hockey Stick at a very low “loss leader” price in order to attract more customers to its store. For instance, Hockey R Us is currently selling the Alkali CA5 Int. Comp Hockey Stick for $64.98 but would like to lower its price to attract customers away from its competitor, Hockey Time. Using this system and referring to FIG. 8A, an employee of Hockey R Us is able to log onto the system using the store's computer (e.g., a retailer's computer, such as retailer computer 152 shown in FIG. 1) and open a user interface 800. The User interface 800 has a first section 805 that allows a retailer to check its compliance with a manufacturer's MAP. In particular, first section 805 has a product entry field 810, a proposed price entry field 815, a submit button 820, a MAP Compliant indicator 825 and a MAP Violation indicator 830. Referring to FIG. 8B, the Hockey R Us employee may then enter the new desired price, $49.99, for the Alkali CA5 Int. Comp Hockey Stick into the system and hit the submit button 820. Because the manufacturer, Alkali, set the MAP for the Alkali CA5 Int. Comp Hockey Stick at $49.99, the system will notify the retailer that the new price complies with the MAP policy highlighting the MAP Compliant indicator 825 as shown in the figure. In addition, this module enables the retailer to enter any price, whether current, proposed, or that of a competitor, to determine whether the price complies. The system also allows the retailer to set up notifications for instances where the retailer's price or the competitor's price falls below the manufacturer's MAP.

### MAP Compliance Reporting and Enforcing Module User Experience

The following describes an exemplary user experience using the MAP Compliance Reporting and Enforcing Module 500. This feature of a particular embodiment enables a first retailer to police the prices used by a second retailer and allows the first retailer to report a potential violation of a MAP policy by the second retailer. For example, Hockey R Us may have seen an ad by its competitor, Hockey Time, listing the Alkali CA5 Int. Comp Hockey Stick for $45.99. Because Hockey R Us also sells the Alkali CA5 Int. Comp Hockey Stick, it may wish to confirm that Hockey Time is complying with Alkali's MAP policy for the Alkali CA5 Int. Comp Hockey Stick. Using the system, a Hockey R Us employee may log onto the system and be directed to a user interface 800 shown in FIG. 8C that has a second section 835 that allows the user to check the compliance of a competitor to a manufacturer's MAP policy. Using this user interface, the Hockey R Us employee may enter the product name, Alkali CA5 Int. Comp Hockey Stick, in the product name entry field 810. The employee also enters the competitor's price, $45.99, in the price field 840 and the competitor's name, Hockey Time, in the name field 845. Once the data is entered, the user selects the submit button 850 to send the data to the system for analysis. In this example, because Hockey Time's price is below Alkali's MAP for the Alkali CA5 Int. Comp Hockey Stick, the MAP Violation indicator 860 is highlighted while the MAP compliance indicator 855 is not. The system may then provide the option to Hockey R Us to notify Alkali of Hockey Time's potential violation, or in other embodiments, the system may automatically send Alkali the information when a MAP violation is detected. The system will then allow Alkali to open up a communication box between itself and Hockey Time to resolve the violation. Hockey Time may respond to this communication directly or may respond indirectly by changing its price for the Alkali CA5 Int. Comp Hockey Stick. Once the violation has been resolved, Alkali may close the communication box and may select whether it wants to send the resolution of the violation to the notifying retailer, Hockey R Us.

### MAP Compliance Monitoring Module User Experience

The following describes an exemplary user experience using the MAP Compliance Monitoring Module 600. In this embodiment, the system automatically monitors the pricing of particular products offered by a particular retailer on the retailer's website. For example, the MAP Compliance Server 100 will access the one or more networks 115 and perform a search for a specific retailer's website, for instance Hockey R Us and Hockey Time. If after accessing the retailers' websites, the system determines that Hockey Time is selling the Alkali CA5 Int. Comp Hockey Stick for $45.99 and Hockey R Us is selling the Alkali CA5 Int. Comp Hockey Stick for $49.99, while Alkali's MAP policy for the Alkali CA5 Int. Comp Hockey Stick is $49.99, the system will automatically generate a notification to Hockey Time and the communication process discussed above will ensue until the violation is resolved.

Finally, a retailer may use the system to retrieve a full listing of all of its products in a certain area to make sure that there are no holes in the retailer's inventory. For instance, using the user interface 700 shown in FIG. 7, Hockey R Us may access the grid showing all of Hockey R Us' products in the first column 730, Hockey R Us' prices in the second column 740, and all competitors selling the same products in the following columns. After running the search for its products, if the first column displays a line for a particular product, Hockey R Us will be able to update the pricing for that particular product.

### Exemplary Advantages of Various Embodiments

Certain embodiments may have particular advantages to one or more retailers or manufacturers. However, not all advantages will be duly applicable to all users or in all situations. The following discusses advantages that may be realized by some manufacturers using particular embodiments. First, the system will allow manufacturers to detect source MAP violations, which will help to improve the quality of MAP enforcement and will make finding such violations easier for the manufacturers. In addition, certain embodiments will allow manufacturers to quickly and effectively update and distribute changes to MAP policies to all retailers using a single computer system.

Similarly, certain embodiments may have particular advantages to one or more retailers. For instance, certain retailers may find certain embodiments to be an effective platform for reporting competitors' violations of MAP policies. Other retailers may find that certain embodiments provide a beneficial platform for quickly and effectively addressing and resolving their own potential MAP violations. Still other retailers may find that certain embodiments provide an effective platform for keeping up to date on manufacturers' product lines and MAP policies. Each of these various advantages will create a more centralized and more effective process that will in turn enable better policing, monitoring, communication, and enforcement regarding manufacturers' MAP policies.

### Alternative Embodiments

In various embodiments, a manufacturer may face difficulty in enforcing MAP guidelines, for example, due to complexity in a supply chain of a particular product that the manufacturer sells. For example, a particular manufacturer may sell their products to a plurality of distributers who may, in turn, distribute the products to a plurality of sellers. These sellers may then offer the products for sale in a plurality of retail stores such as, for example, online retail stores, physical storefronts, online marketplaces, etc. In some embodiments, a manufacturer may be left attempting to enforce its MAP guidelines against thousands of potential sellers. In particular embodiments, a managed MAP enforcement system such as the managed MAP enforcement system generally described herein, may further be configured to facilitate connections among different parties in a supply chain between and/or among manufacturers, distributers, sellers, and/or third party marketplaces (e.g., up and down the supply chain). These connections may include, for example, one or more communication channels, one or more data-sharing channels, one or more content-sharing channels, creating one or more links with manufacturer databases, etc. Such connections may, for example, enable a manufacturer to systematically police and enforce its MAP guidelines at all levels of distribution and at every possible point of sale. The system may also help to assure other parties in the supply chain that the MAP policies are being enforced.

Various embodiments of a managed MAP enforcement system may include functionality in addition to the functionality described above. For example, in particular embodiments, a managed MAP enforcement system may be configured to facilitate a connection between a manufacturer of a particular product and a third party marketplace in order to facilitate enforcement of one or more MAP guidelines provided by the manufacturer. Such enforcement may for example, include facilitating an approval process for sellers and/or distributers who may desire to list one or more of the manufacturer's products for sale via the third party marketplace. FIG. 9 is a flow chart of operations performed by an exemplary MAP Enforcement via Connections Module 900, which may, for example, run on the MAP Compliance Server 100, or any other suitable computing device. In particular embodiments, the MAP Enforcement via Connections Module 900 may facilitate a connection between a manufacturer and one or more third party marketplaces, enable the manufacturer to provide one or more MAP guidelines to the third party marketplace via the connection, and/or enable the third party marketplace to provide to the manufacturer data associated with one or more sellers requesting to list one or more of the manufacturer's products via the third marketplace. Although the MAP Enforcement via Connections Module 900 is described in the context of a manufacturer and a third party marketplace, the module may further be configured to facilitate connections between a manufacturer and a distributer, a distributer and a seller, a seller and a third party marketplace, etc.

Distributers wishing to distribute a manufacturer's product may, for example, wish to connect with a manufacturer. In various embodiments, the MAP Enforcement via Connections Module 900 may enable a particular distributer to connect with such a manufacturer, and demonstrate a record of MAP compliance that the distributer has with other manufacturers with which it is connected to help convince the particular manufacturer to utilize he distributer as an authorized distributer.

### MAP Enforcement via Connections Module 900

In various embodiments, as shown in FIG. 9, the MAP Enforcement via Connections Module 900 begins at Step 910 by receiving a request to establish a connection between a manufacturer and a third party marketplace to facilitate enforcement of one or more MAP guidelines from a manufacturer. In particular embodiments, the manufacturer may include any manufacturer that produces any suitable product that may be offered for sale (e.g., via a third party online marketplace or other avenue). In various embodiments, the third party marketplace may include any suitable marketplace which may, for example, enable one or more sellers and/or distributers to list one or more products for sale (e.g., via an online retail store). Such third party marketplaces (e.g., retailers) may include, for example, Amazon.com, Walmart, Best Buy, eBay, etc. In various embodiments, the third party marketplace may provide a means through which a seller can list a product for sale. In such embodiments, customers who purchase the product through the third party marketplace may have their order fulfilled by a seller that has listed a product for sale through the third party marketplace. In various embodiments, the third party marketplace may enable a plurality of sellers to offer the same product for sale via the third party marketplace (e.g., multiple sellers may offer the same make and model of a toothbrush for sale.

In various embodiments, the request to establish the connection may be initiated by the manufacturer or the third party marketplace. In particular embodiments, the system may receive the request through a user interface provided by a third party company that facilitates connections between manufacturers and third party marketplaces. In various embodiments, the request to create the connection includes a request to initiate free flowing communication (e.g., of data, information, etc.) between the manufacturer and the third party marketplace. In still other embodiments, the request to establish the connection may be a request to access particular data, or a particular file or data structure (e.g., on a database, server, etc.).

Continuing at Step 920, the system, at least partially in response to receiving the request, establishes the connection. In various embodiments, establishing the connection comprises enabling two way (e.g., or one way) communication between the manufacturer and the third party marketplace, for example, via a suitable software application, web application, or other application. In various embodiments, the connection is a secure (e.g., or unsecure) connection that is configured to facilitate a transfer of data between the manufacturer and the third party marketplace. In particular embodiments, establishing the connection comprises creating a link between a manufacturer database and a third party marketplace data base. The manufacture database may, for example, include product data and associated MAP policies for the product.

The product data may include, for example, one or more data fields such as: (1) Product Name; (2) Product Descriptions; (3) Brand Name; (4) Brand Stock Keeping unit (SKU); (5) MSRP; (6) MAP; (7) One or more names of prohibited marketplaces; (8) Closeout status (e.g., whether the item is a closeout item); (9) Size; (10) gender designation; (11) Shape; (12) Color; (13) One or more images (e.g., one or more image files, one or more links to one or more hosted images, etc.); (14) Style Code; (15) Series; (16) Category; and/or (17) any other data field associated with the product. In particular embodiments, in response to establishing the connection between the manufacturer and the third party marketplace, the system may be configured to link the product data stored in the manufacturer database for a particular product with product data for the particular product stored in the third party marketplace database. The manufacturer may then automatically provide product data updates to the third party retailer via the linked databases.

For example, the system may be configured such that one or more modification to product data by the manufacturer in the manufacturer database automatically triggers a transfer of the updated data to the third party retailer database and modification of the data in the third party retailer database to match the product data in the manufacturer database. In various embodiments, automatically modifying corresponding product data in a third party retailer database may enable the system to make determinations based on the third party retailer database without having to make a database call to the manufacturer database to receive updated data (e.g., because the third party retailer database is already up to date). This may conserve processing and networking resources at the time of later determinations, for example, by limiting third party retailer database updates to off-peak networking times, times of low processing use, etc. In particular embodiments, the system may be configured to only transfer individual fields that have been modified for the product data to the third party retailer in response to modification. This may further limit the use of processing and networking usage by the system.

The system may, for example: (1) determine which particular fields associated with product data have been modified; (2) transfer data containing the modified field data to the third party retailer database via the connection; and (3) modify the data in the third party retailer database to include the modified field data (e.g., without having to modify or unnecessarily transfer any unmodified data).

In particular embodiments, establishing the connection comprises enabling the manufacturer to provide one or more MAP guidelines to the third party marketplace. In such embodiments, the system may be configured to transmit the one or more MAP guidelines using any suitable technique. In other embodiments, the system may be configured to provide the one or more MAP guidelines to the third party marketplace by providing access to the one or more MAP guidelines which may, for example, be stored in any suitable location and/or locations (e.g., such as on one or more servers).

In particular embodiments, the one or more MAP guidelines may include any suitable MAP guidelines such as, for example, any suitable MAP guidelines discussed above (e.g., a minimum advertised price for a particular product, one or more restrictions on bundling a particular product, regional sales limitations on a particular product, etc. In still other embodiments, the one or more MAP guidelines may include one or more guidelines to grant or deny permission for a particular seller to sell a particular manufacturer product (e.g., via a black list, via a whitelist, or both). In such embodiments, a blacklisted seller may be a particular seller that has previously violated one or more MAP guidelines. In various embodiments, the one or more seller-specific MAP guidelines may include one or more additional (e.g., more stringent) guidelines on a seller that has previously violated one or more MAP guidelines. In other embodiments, the one or more MAP guidelines may include a particular time limit on how long a seller must adhere to such seller specific guidelines (e.g., one day, one month, one year, or any other suitable period of time). For example, a manufacturer may desire to prevent a seller that has violated a MAP guideline on a first third party marketplace from selling any manufacturer products on a second third party marketplace for a particular period of time.

In still other embodiments, the one or more MAP guidelines may include one or more questions which a third party marketplace must ask potential sellers in order to authorize the potential seller to list a manufacturer product for sale. For example, the one or more questions may include one or more questions relating to: (1) a source from which the potential seller received the manufacturer product for sale; (2) an amount of stock of the manufacturer product the potential seller possesses; (3) whether the potential seller is an authorized seller of manufacturer products; (4) what is the region or regions in which the potential seller is interested in selling (e.g., country); (5) contact information for one or more agents, employees, etc. of the potential seller; etc.

In various embodiments, the connection includes any suitable connection such as a networking link, associative link stored in memory, or any other suitable link such as any link described herein. In particular embodiments, the connection may enable a transfer of data from any of a plurality of third party retailers or distributers to the manufacture (e.g., to a manufacturer database on a suitable manufacturer server). For example, one or more third party retailers may transfer data associated with one or more MAP violations of a seller that the third party retailer has collected on behalf of another manufacturer. The manufacturer may then use this data to make determinations regarding authorizing new sellers to list their products. The manufacturer may also update product information to include such sellers on a black or white list and dissemination such information to all third party retailers and distributers with which the manufacturer is connected (e.g., by updating the product data in a manufacturer database to trigger the system automatically pushing the updated data to connected retailers and others).

Returning to Step 930, the system receives the one or more MAP guidelines from the manufacturer. The system may then, at Step 940, store the one or more MAP guidelines in memory. Next, the system may, at Step 950, receive a request from a seller to list one or more manufacturer products on the third party marketplace. Continuing to Step 960, the system determines, based at least in part on the one or more MAP guidelines, whether to enable the seller to list the one or more manufacturer products on the third party marketplace. The system may, for example, determine whether the seller is an authorized or unauthorized seller of manufacturer products. In various embodiments, the system may substantially automatically determine whether to enable the seller to list the one or more manufacturer products. In other embodiments, the system may enable a user to approve or deny a request from a seller to list a manufacturer product on the third party marketplace. In such emboldens, the system may also generate a recommended action for the user based at least in part on the one or more MAP guidelines, and provide that recommendation to the user (e.g., by displaying the recommendation on a suitable computing device display).

In various embodiments, the system determines whether to enable the seller to list the one or more manufacturer products on the third party marketplace based in part on information derived from a plurality of other third party retailers with which the manufacturer is connected. For example, the system may receive additional information about the requesting seller from one or more other distributers that have provided product to the seller, one or more other marketplaces through which the seller has listed products, etc. In various embodiments, the system determines whether to enable the seller to list the one or more manufacturer products on the third party marketplace based on whether the seller has listed particular products using provided manufacturer data (e.g., via a direct connection as described herein). Differences in product description and other product data in published offers for sale by the product for the seller may, for example, cause the system to determine not to enable the seller to list the one or more manufacturer products.

In various other embodiments, the system may be configured to enable the manufacturer to update (e.g., alter) the one or more MAP guidelines. In such embodiments, the system may be configured to substantially automatically determine whether previously approved sellers are still approved under the updated one or more MAP guidelines. The system may, in various embodiments rescind approval for sellers that are no longer approved, notify the third party marketplace or the manufacturer of the change in status of particular sellers, or take any other suitable action.

Continuing to step 970, the system provides a notification to the manufacturer from the third party marketplace detailing the determination made at Step 960. In various embodiments, the system may further enable the manufacture to overturn or veto the determination made at Step 960. For example, the manufacturer may reject a seller that was approved to list a manufacturer product for sale via the third party marketplace at Step 960.

Although the MAP Enforcement via Connections Module 900 is discussed above with respect to a manufacturer and a third party marketplace, it should be understood that the MAP Enforcement via Connections Module 900, in various embodiments, may be executed to establish any suitable connection(s) between and/or among any suitable manufacturer, any suitable distributer, any suitable seller, and/or any suitable third party marketplace.

### Seller Specific MAP Enforcement Module 1000

As shown in FIG. 10, in various embodiments, a manufacturer may wish to blacklist a particular seller who may have violated one or more of the manufacture's MAP guidelines. In various embodiments, a particular seller may list one or more manufacturer products for sale via a plurality of online or other marketplaces. In such embodiments, a manufacturer may desired a streamlined way in which to blacklist the seller from selling the manufacturer's products in any and all marketplaces (e.g., even if the seller only committed a MAP violation in one particular marketplace). In particular embodiments, the system may be configured to generate a blacklist based on incidences of MAP non-compliance from sellers and distribute the blacklist via one or more connections which the manufacturer has made via the MAP Enforcement via Connections Module 900 described above. The blacklist may be included, for example, in the one or more MAP guidelines provided by the manufacturer and received by the system at step 940 described above.

When executing the Seller Specific MAP Enforcement Module 1000, the system begins, at Step 1010 by receiving one or more seller blacklisting rules. The system may be configured to receive the one or more seller blacklisting rules from a particular manufacturer. In various embodiments, the one or more seller blacklisting rules may include, for example, one or more rules regarding: (1) an allowable number of MAP violations in a particular time period; (2) a frequency of determined MAP violations; (3) a severity of a particular MAP violation; (4) one or more ‘punishments’ for a particular MAP violation (e.g., a particular amount of time a violating seller should be placed on the blacklist, a particular product for which the seller should be blacklisted form selling, etc.); (5) etc.

Continuing at Step 1020, the system receives an indication of one or more MAP violations by a particular seller. The system may receive the indication, for example, in any suitable manner disclosed herein (e.g., in response to determining that a particular product is being offered for sale in violation of one or more MAP guidelines and/or policies, via a report provided by a competitor of the offending seller, or from any other suitable source). The system then, at Step 1030, determines, based at least in part on the one or more seller blacklisting rules and the one or more MAP violations by the particular seller, whether to blacklist the particular seller. Next, at Step 1040, the system, at least partially in response to determining to blacklist the particular seller, adds the seller to a blacklist. At Step 1050, the system continues by storing the blacklist to memory.

### Illustrative Example

In a particular example of MAP Enforcement via Connections Module 900 described above, the system may, for example, receive a request from a first manufacturer (e.g., Generic Toy Company) to establish a connection with an online marketplace (e.g., ABC-Shopping.com). In response to the request, the system may establish a connection between Generic Toy Company and ABC-Shopping.com through which Generic Toy Company can provide MAP guidelines for all of Generic Toy Company's products. The MAP guidelines may include the name of a particular seller (e.g., MAP Violating Sales Co.) that Generic Toy Company has found to have committed repeated MAP violations through other online marketplaces in the past. The system may then store the MAP guidelines in memory.

ABC-Shopping.com may then receive a request from a potential seller to list a Generic Toy Company product for sale via ABC-Shopping.com. ABC-Shopping.com may then request additional information about the potential seller and determine, based at least in part on the additional information and the MAP guidelines, whether to authorize the potential seller to list the Generic Toy Company product for sale on ABC-Shopping.com. The system may, for example, determine that the potential seller is MAP Violating Sales Co. and reject the request. In response to determining that the potential seller is authorized to list the product based on the MAP guidelines, the system may then notify the manufacturer. The manufacturer may then manually override the decision of the third party marketplace.

### CONCLUSION

Many modifications and other embodiments of the invention will come to mind to one skilled in the art to which this invention pertains having the benefit of the teachings presented in the foregoing descriptions and the associated drawings. For example, instead of having a separate user interface 800 that allows the user to enter pricing to check compliance with a MAP, the user may engage the user interface 700 for reporting MAP violations. In particular, when a price is shown with cross hatching (e.g., is red), the user may click on that particular pricing to send a note to the manufacturer. Additionally, an additional column may be added to the user interface 700 that allows a user to input a proposed price for a particular item, which then causes the system to check the proposed price against the manufacturer's MAP policy for that item. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A computer system for facilitating enforcement of one or more MAP guidelines for a plurality of products from a manufacturer by establishing a direct connection between the manufacturer and each of a plurality of third party marketplaces for the transfer of product data and MAP data, the computer system comprising at least one processor and memory, wherein the computer system further comprises:
a. executable software operatively installed on a manufacturer computing device associated with the manufacturer, the executable software displaying a user interface, on a display screen of the manufacturer computing device, that is adapted to receive, via input on the user interface, updated product data and updated MAP data;
b. executable software operatively installed on a computing device associated with each of the plurality of third party marketplaces, the executable software displaying a user interface, on a display screen of the computing device, that is adapted to receive a request to authorize a new seller to list a particular one of the plurality of products via a particular one of the plurality of third party marketplaces;
c. a manufacturer database storing the product data and the MAP data, and
d. one or more third party retailer databases associated with each of the plurality of third party marketplaces and storing corresponding product data, corresponding MAP data, and third party manufacturer data wherein the system is adapted for:
establishing a connection between the manufacturer database and the one or more third party retailer databases;
in response to receiving updated product data and updated MAP data from the manufacturer, automatically updating the corresponding product data and the corresponding MAP data;
in response to receiving the request to authorize the new seller to list the particular one of the plurality of products via a particular one of the plurality of third party marketplaces, automatically determining whether to authorize the new seller to list the particular one of the plurality of products based at least in part on the corresponding product data and the corresponding MAP data;
in response to determining not to authorize the new seller to list the particular one of the plurality of products, modifying the product data to include data associated with the new seller as an unauthorized seller; and
in response to modifying the product data to include data associated with the new seller as an unauthorized seller, automatically updating the corresponding product data to include the data associated with the new seller as an unauthorized seller.

2. The computer system of claim 2, wherein establishing the connection between the manufacturer database and the one or more third party retailer databases comprises:
creating an associative link between the manufacturer database and the one or more third party retailer databases; and
storing the associative link in memory.

3. The computer system of claim 2, wherein the corresponding product data comprises data selected from a group consisting of:
a. one or more blacklisted sellers; and
b. one or more whitelisted of sellers.

4. The computer system of claim 3, wherein:
the third party manufacturer data comprises one or more MAP violations associated with a plurality of sellers; and
automatically determining whether to authorize the new seller to list the particular one of the plurality of products is further based at least in part on the third party manufacturer data.

5. The computer system of claim 2, wherein:
the product data comprises a blacklist of sellers for each of the plurality of products; and
the computer system is further adapted for:
transmitting data associated with the one or more MAP violations from the one or more third party retailer databases associated with each of the plurality of third party marketplaces to the manufacturer database via the connection between the manufacturer database and the one or more third party retailer databases;
modifying the blacklist of sellers based at least in part on the one or more MAP violations; and
in response to modifying the blacklist of sellers, automatically updating the corresponding product data to include the modified blacklist of sellers.

6. The computer system of claim 5, wherein:
automatically updating the corresponding product data and the corresponding MAP data comprises automatically updating the corresponding product data and the corresponding MAP data in substantially real-time such that the corresponding product data and the corresponding MAP data substantially match the product data and the MAP data product data.

7. The computer system of claim 1, wherein automatically determining whether to authorize the new seller to list the particular one of the plurality of products based at least in part on the corresponding product data and the corresponding MAP data comprises determining whether to authorize the new seller without requesting any data from the manufacturer database via the connection.

8. A computer-implemented method of facilitating enforcement of one or more MAP guidelines for a plurality of products from a manufacturer by establishing a direct connection between a manufacturer and a third party marketplace, the method comprising:
a. receiving, by a processor, a request to establish a connection between the manufacturer and the third party marketplace to facilitate enforcement of the one or more MAP guidelines form the manufacturer;
b. at least partially in response to receiving the request, establishing the connection by a processor, wherein establishing the connection comprises:
i. establishing a direct communication channel between a manufacturer database storing manufacturer product data for the plurality of products and a third party retailer database storing third party retailer product data for the plurality of products;
ii. creating a link, in memory, between the manufacturer product data and the third party retailer product data;
iii. enabling the manufacturer to provide the one or more MAP guidelines to the third party marketplace via the direct communication channel; and
iv. enabling the third party marketplace to provide data associated with one or more sellers requesting to sell one or more manufacturer products via the third party marketplace to the manufacturer via the direct communication channel;
c. receiving, by a processor, the one or more MAP guidelines from the manufacturer;
d. in response to receiving the one or more MAP guidelines from the manufacturer, modifying the manufacturer product data to include the one or more MAP guidelines;
e. in response to modifying the manufacturer product data to include the one or more MAP guidelines, automatically transferring the modified manufacturer product data via the direct communication channel and modifying the third party retailer product data to include the one or more MAP guidelines;
f. receiving a request from a seller to list one or more manufacturer products on the third party marketplace;
g. determining, by a processor, based at least in part on the third party retailer product data, whether to enable the seller to list the one or more manufacturer products on the third party marketplace; and
h. at least partially in response to determining to enable the seller to list the one or more manufacturer products, enabling the seller, by a processor, to list the one or more manufacturer products on the third party marketplace; and
i. providing a notification, by a processor, to the manufacturer from the third party marketplace detailing the determination made at Step g via the direct communication channel.

9. The computer implemented-method of claim 8, further comprising enabling, by a processor, the manufacturer to overrule the determination of whether to enable the seller to list the one or more manufacturer products on the third party marketplace by transmitting a notification via the direct communication channel.

10. The computer-implemented method of claim 8, wherein the one or more MAP guidelines comprise one or more MAP guidelines selected form a group consisting of:
a. a blacklist of sellers; and
b. a whitelist of sellers.

11. The computer-implemented method of claim 8, wherein:
the manufacturer product data comprises a plurality of manufacturer product fields;
the third party retailer product data comprises a plurality of corresponding third party retailer product fields; and
the method further comprises:
receiving, from the manufacturer, a modification to a first manufacturer product field; and
in response to receiving the modification:
updating the first manufacturer product field in the manufacturer database;
transmitting data associated with the updated first manufacturer product field via the direct communication channel; and
automatically modifying a first corresponding third party retailer product field to include the data associated with the updated first manufacturer product field.

12. The computer-implemented method of claim 11, the method further comprising:
automatically modifying, by one or more processors, the third party retailer product data to include one or more modifications to the manufacturer product data in substantially real-time such that the third party retailer product data substantially matches the manufacturer product data.

13. The computer-implemented method of claim 8, wherein the manufacturer product data comprises the one or more MAP guidelines.

14. The computer-implemented method of claim 8, wherein:
the manufacturer product data comprises data associated with one or more approved sellers, wherein the data comprises one or more pieces of contact information for the one or more approved sellers; and
determining, by a processor, based at least in part on the third party retailer product data, whether to enable the seller to list the one or more manufacturer products on the third party marketplace comprises:
using the one or more pieces of contact information to determine if the seller is one or the one or more approved sellers.

15. The computer implemented method of claim 8, further comprising:
receiving, by a processor, a request to establish one or more connections between the manufacturer and each of a plurality of third party marketplaces,
at least partially in response to receiving the request, establishing the one or more connections by a processor, wherein establishing the one or more connections comprises:
i. establishing a direct communication channel between the manufacturer database each of a plurality of third party retailer databases storing third party retailer product data for the plurality of products;
ii. creating a link, in memory, between the manufacturer database and each of the plurality of third party retailer databases;
iii. enabling the manufacturer to provide the one or more Map guidelines to the each of the plurality of third party marketplaces via the respective one more direct communication channels; and
iv. enabling each of the plurality of third party marketplaces to provide data associated with one or more sellers requesting to sell one or more manufacturer products via each of the plurality of third party marketplaces to the manufacturer via the respective one or more direct communication channel.

16. The computer-implemented method of claim 15, the method further comprising:
receiving a request from a seller to list one or more manufacturer products on the third party marketplace; and
determining whether to enable the seller to list the one or more manufacturer products on the third party marketplace based on one or more pieces of data received from each of the plurality of third party retailers about the seller via the respective one or more direct communication channels.

17. The computer-implemented method of claim 8, the method further comprising enabling direct, two-way communication between the manufacturer and the third party retailer via the direct communication channel.

18. A computer system for managing compliance with one or more minimum advertised pricing policies by generating a blacklist of non-compliant venders, the system comprising:
a. at least one processor; and
b. memory, wherein the computer system is configured for:
i. receiving a first set of data that includes minimum advertised pricing information for a particular product made by a manufacturer, the minimum advertised pricing information reflecting at least a portion of a minimum advertised pricing policy established by the manufacturer;
ii. storing the first set of data in the memory;
iii. receiving a request, from a user, to confirm that a particular price for a particular product complies with the minimum advertised pricing policy;
iv. at least partially in response to receiving the request, using the first set of data to determine whether the particular price for the particular product complies with the minimum advertised pricing policy;
v. at least partially in response to determining that the particular price for the particular product complies with the minimum advertised pricing policy, one of:
informing the user that the particular price for the particular product complies with the minimum advertised pricing policy; and
informing the user that the particular price for the particular product does not comply with the minimum advertised pricing policy
vi. at least partially in response to determining that the particular price for the particular product does not comply with the minimum advertised pricing policy:
a. determining a vender offering the particular product for sale at the particular price that does not comply with the minimum advertised pricing policy;
b. receive one or more seller blacklisting rules;
c. receive an indication of one or more additional MAP violations by the vender;
d. determine, based at least in part on the one or more seller blacklisting rules and the one or more additional MAP violations, whether to blacklist the vender;
e. at least partially in response to determining to blacklist the vender, adding the vender to a blacklist; and
f. storing the blacklist to memory.

19. The computer system of claim 18, wherein the step of using the first set of data to determine whether the particular price for the particular product complies with the minimum advertised pricing policy comprises:
a. comparing the particular price with a minimum advertised price established by the minimum advertised pricing policy; and
b. in response to the particular price being greater than or equal to the minimum advertised price, determining that the particular price for the particular product complies with the minimum advertised pricing policy.

20. The computer system of claim 19, wherein the computer system is further configured for providing the blacklist to an entity selected from a group consisting of:
a. a third party marketplace on which the particular product is offered for sale;
b. a distributer to which a manufacturer of the particular product has provided the particular product for distribution; and
c. a seller of the particular product.
